(19) United States
(12) Patent Application Publication
(10) Pub. No.: US 2026/0064190 A1
(43) Pub. Date: Mar. 5, 2026

(54) DISPLAY IMAGE GENERATION APPARATUS AND DISPLAY IMAGE GENERATION METHOD

(71) Applicant: Sony Interactive Entertainment Inc., Tokyo (JP)

(72) Inventors: Mitsuru Nishibe, Chiba (JP); Daisuke Tsuru, Chiba (JP); Tatsuo Tsuchie, Tokyo (JP); Yuko Hayakawa, Tokyo (JP)

(73) Assignee: Sony Interactive Entertainment Inc., Tokyo (JP)

(21) Appl. No.: 19/294,121

(22) Filed: Aug. 7, 2025

(30) Foreign Application Priority Data
Sep. 3, 2024 (JP) 2024-151463

(51) Int. Cl. G06F 3/01; G06T 7/246; G06T 19/20

(52) U.S. Cl. CPC G06F 3/011; G06F 3/017; G06T 7/251; G06T 19/20; G06T 2207/30196; G06T 2219/2004

(57) ABSTRACT

There is provided a display image generation apparatus including a state information acquisition section configured to acquire state information in a three-dimensional space regarding a target in a real world, a skeleton model control section configured to apply a spring model to a position corresponding to a bone between nodes represented by the state information so as to adjust positions of the nodes, the spring model having a natural length constituting an ideal distance based on a skeleton model of a virtual object corresponding to the target, and, a display image generation section configured to generate a display image including the virtual object reflecting the skeleton model formed by the adjusted nodes.

### CROSS REFERENCE TO RELATED APPLICATION

This application claims priority to Japanese Patent Application JP 2024-151463 filed Sep. 3, 2024, the entire contents of which are incorporated herein by reference.

### BACKGROUND

The present disclosure relates to a display image generation apparatus and a display image generation method for generating a display image that includes a virtual object.

The technology for giving users a sense of immersion in a virtual space using a head-mounted display or like device has become a familiar tool regardless of a field. For example, the sense of presence in the virtual world can be enhanced by moving a displayed virtual object in a manner interacting with the user's movements or by giving the user a tactile feedback. In a case of content such as electronic games, treating the user's motion as operating means provides more intuitive operations than when an input device such as a controller is used. For example, if the user's hand movements are reflected in virtual hands in a display world, it is possible to handle objects in the display world similarly as in a real world.

### SUMMARY

In the case where a virtual object moving synchronously with the user's body is presented in the display world, even a slight error on the display can detract from the sense of presence. Especially in a mode where the user's movements are instantaneously reflected in a virtual object being displayed, temporal constraints can make it difficult to accurately display the virtual object.

The present disclosure has been made in view of the above circumstances. It is desirable to provide a technology that enables a virtual object moving synchronously with the user to be displayed with low delay and high accuracy.

According to one embodiment of the present disclosure, there is provided a display image generation apparatus including a state information acquisition section configured to acquire state information in a three-dimensional space regarding a target in the real world, a skeleton model control section configured to apply a spring model to a position corresponding to a bone between nodes represented by the state information so as to adjust the positions of the nodes, the spring model having a natural length constituting an ideal distance on the basis of a skeleton model of a virtual object corresponding to the target, and a display image generation section configured to generate a display image including the virtual object reflecting the skeleton model formed by the adjusted nodes.

According to another embodiment of the present disclosure, there is provided a display image generation method including acquiring state information in a three-dimensional space regarding a target in the real world, applying a spring model to a position corresponding to a bone between nodes represented by the state information so as to adjust the positions of the nodes, the spring model having a natural length constituting an ideal distance on the basis of a skeleton model of a virtual object corresponding to the target, and generating a display image including the virtual object reflecting the skeleton model formed by the adjusted nodes.

It is to be noted that suitable combinations of the above constituent elements as well as modes obtained by converting expressions of the present disclosure between a method, an apparatus, a system, a computer program, and a recording medium that records the computer program, among others, are also effective as modes of the present disclosure.

The present disclosure outlined above thus makes it possible to display a virtual object moving synchronously with the user with low delay and high accuracy.

### BRIEF DESCRIPTION OF THE DRAWINGS

FIG. 1 is a view depicting an exemplary appearance of a head-mounted display to which the embodiment of the present disclosure may be applied;

FIG. 2 is a view depicting an exemplary configuration of a content processing system to which the embodiment of the present disclosure may be applied;

FIGS. 3A and 3B depict views illustrating exemplary display images generated by a content processing apparatus according to the embodiment of the present disclosure;

FIG. 4 is a view schematically depicting basic steps to have state information regarding a real hand reflected in a hand object according to the embodiment of the present disclosure;

FIGS. 5A and 5B depict views illustrating problems resulting from display deviations of the hand object;

FIGS. 6A, 6B, and 6C depict views illustrating how spring models are introduced in setting a skeleton model of the hand according to the embodiment of the present disclosure;

FIG. 7 is a view depicting an internal circuit configuration of the content processing apparatus according to the embodiment of the present disclosure;

FIG. 8 is a view depicting functional blocks of the content processing apparatus according to the embodiment of the present disclosure;

FIGS. 9A, 9B, and 9C depict views for explaining a specific example of a method by which a skeleton model control section according to the embodiment of the present disclosure fits state information to a skeleton model;

FIG. 10 is a view for explaining a specific example of a method by which the skeleton model control section according to the embodiment of the present disclosure has a touch operation reflected in a skeleton model; and

FIG. 11 is a flowchart indicating a processing procedure performed by the content processing apparatus according to the embodiment of the present disclosure to generate and output a display image that includes a hand object reflecting motions of a user's hand.

### DETAILED DESCRIPTION OF THE PREFERRED EMBODIMENT

The embodiment of the present disclosure relates to a technology that represents at least a portion of a user's body as a virtual object and causes it to synchronize with an actual motion of the body. In this respect, means for detecting actual movements and means for displaying images are not limited to anything specific. The description that follows focuses on how the user's hand motion is tracked on the basis of images captured by cameras mounted on a head-mounted display and how the tracked motion is reflected in a hand motion in the display world.

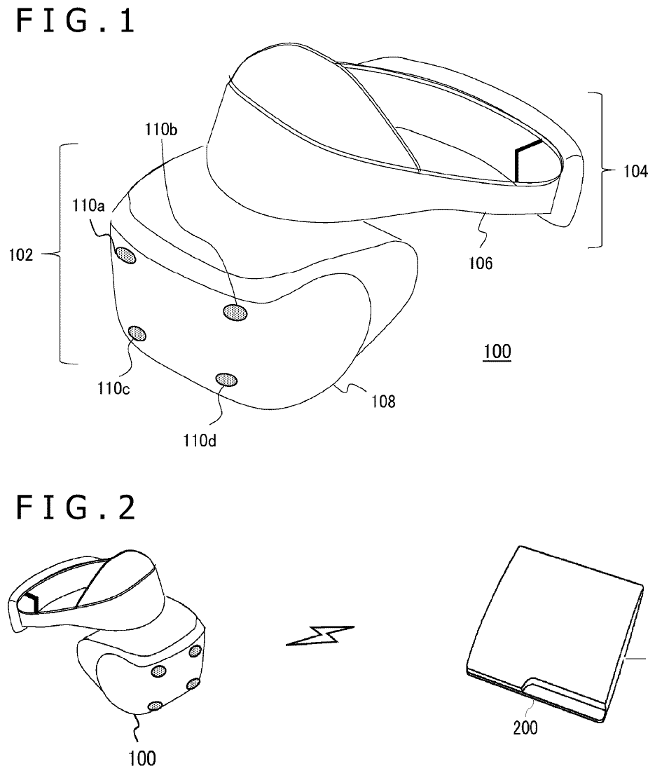

FIG. 1 is a view depicting an exemplary appearance of a head-mounted display 100 to which the embodiment of the present disclosure may be applied. In this example, the head-mounted display 100 is configured by an output mechanism part 102 and a wearing mechanism part 104. The wearing mechanism part 104 includes a wearing band 106 which, when worn by the user, surrounds the user's head in a manner securing the apparatus. The output mechanism part 102 includes a housing 108 shaped to cover both eyes of the user wearing the head-mounted display 100, the housing 108 including display panels directly facing the eyes.

The housing 108 also includes inside thereof eyepieces interposed between the display panels and the user's eyes when the head-mounted display 100 is worn, the eyepieces being disposed to enlarge images. The head-mounted display 100 may further include inside thereof speakers or earphones at positions corresponding to the user's ears when the head-mounted display 100 is worn. The head-mounted display 100 may also incorporate motion sensors such as an acceleration sensor, a gyro sensor, and a geomagnetic sensor to detect translational and rotational movements of the user's head wearing the head-mounted display 100, as well as to detect the position and posture of the user's head at a given point in time.

The head-mounted display 100 includes cameras 110a, 110b, 110c, and 110d at a front of the housing 108 to capture moving images of the user and of the surrounding real space. In the example of the illustration, the cameras 110a, 110b, 110c, and 110d are located at four corners at the front of the housing 108, although their numbers and locations are not limited. In the ensuing description, the cameras 110a, 110b, 110c, and 110d may be generically referred to as the camera or cameras 110 where appropriate. Successively analyzing frames of the moving images captured by the cameras 110 makes it possible to trace the user's hand motion in the field of view of the cameras 110 in a three-dimensional space. The portions and units of the target to be tracked are not limited; they may be the feet, the upper body, the lower body, or the entire body of the user.

The images captured by the cameras 110 may be used to acquire the position and posture of the head-mounted display 100 as well as the position and posture of the user's head through what is known as visual simultaneous localization and mapping (V-SLAM). The V-SLAM is a technique that acquires the camera positions and postures while creating an environmental map by repeating two processes: a process in which a three-dimensional position of a given object is estimated from the positional relations between images of the same real object captured from multiple perspectives, and a process in which the camera positions and postures are estimated on the basis of the estimated positions of the real object in the captured images.

When the field of vision of images displayed on the head-mounted display 100 is varied in a manner corresponding to the position and posture of the user's head obtained by V-SLAM, the user can acquire a sense of immersion in the display world. The images captured by some of the cameras 110 and displayed instantaneously on the head-mounted display 100 provide a see-through mode that allows the user to view a state of a real world in a direction the user faces.

FIG. 2 is a view depicting an exemplary configuration of a content processing system to which the embodiment of the present disclosure may be applied. The head-mounted display 100 is connected to a content processing apparatus 200 by wireless communication or via an interface such as universal serial bus (USB) type-C for connection with peripheral devices. The content processing apparatus 200 may be further connected to a server via a network. In this case, the server may supply the content processing apparatus 200 with online applications such as games that may be participated in by multiple users via a network.

The content processing apparatus 200 basically processes content programs to generate display images and audio data for transmission to the head-mounted display 100. The head-mounted display 100 receives the transmitted display images and audio data before outputting them as images and sounds of the content. Here, the content processing apparatus 200 successively acquires frame data of moving images captured by the cameras 110 of the head-mounted display 100 and, on the basis of the acquired frame data, obtains instantaneously the state information regarding the user's hands.

The content processing apparatus 200 presents a virtual object of the hands in display images and causes the state information regarding the user's hands to be successively reflected therein. This makes it possible to display hand images moving like the user's actual hands. Since the target whose state is to be tracked by use of captured images is not limited to the hands as discussed above, the synchronously moving virtual object may be varied depending on the target to be tracked. The processes performed by the content processing apparatus 200 using this scheme are not limited to anything specific. For example, the content processing apparatus 200 may generate display images indicating a virtual object being lifted or otherwise moved in synchronization with the hand motion. The content processing apparatus 200 may alternatively recognize a gesture made by the user's hands as a command input and perform information processing accordingly.

Also, the content processing apparatus 200 may successively acquire information regarding the position and posture of the user's head by such technology as the above-described V-SLAM and generate display images in a corresponding field of vision. At this time, the content processing apparatus 200 may acquire measurements taken by motion sensors inside the head-mounted display 100 so as to obtain the position and posture of the user's head with higher accuracy.

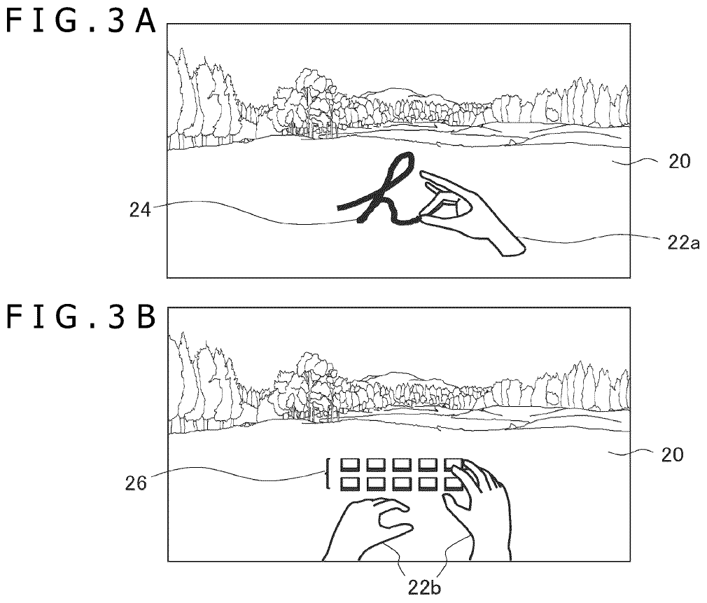

FIGS. 3A and 3B depict views illustrating exemplary display images generated by the content processing apparatus 200 according to the embodiment of the present disclosure. The display images in both figures assume that the user is in an outdoor virtual space 20, with hand objects 22a and 22b being presented. The content processing apparatus 200 acquires the state information regarding the hands in the real world based on the captured images sent from the head-mounted display 100, and causes the acquired information to be successively reflected in the state of the hand objects 22a and 22b.

The display image in FIG. 3A indicates a scene in which a letter 24 is written in the virtual space 20 by the hand object 22a. In this example, the content processing apparatus 200 recognizes a letter-writing mode upon detecting a gesture involving the tips of the middle finger and ring finger touching the tip of the thumb, with the index finger and little finger pointing upward. In this mode, the user's hand motion is synchronized with the hand object 22a, so that a locus drawn by the fingertips of the middle and other fingers is presented as the letter 24.

At this time, the content processing apparatus 200 sets a three-dimensional model of the hand object 22a in a virtual three-dimensional space in a manner corresponding to the hand state information, and presents the model in the display image together with other objects. The content processing apparatus 200 then causes a linear object to appear indicative of the locus of the fingertips in synchronization with the motion of the hand object 22a. As a result, the displayed letter 24 is defined as three-dimensional lines. This allows the letter 24 to be viewed at an angle or from behind if the user wearing the head-mounted display 100 changes his/her point of view.

The display image in FIG. 3B indicates a scene in which a keyboard 26 in the virtual space 20 is operated by the hand object 22b. When the user moves his/her hands to operate desired keys on the keyboard 26 while viewing the display image, the hand object 22b moves in synchronism to perform key operations. In this case, the content processing apparatus 200 identifies the operated keys by determining collisions between the keyboard 26 and the fingertips in the virtual three-dimensional space, on the basis of the hand state information.

In parallel with the above operations, the content processing apparatus 200 sets a three-dimensional model of the hand object 22b in the virtual three-dimensional space in a manner corresponding to the hand state information, and presents the model in the display image together with the keyboard 26 and other objects. The content processing apparatus 200 may displace or discolor the keys operated on the keyboard 26 in such a manner that the keys appear to be pressed by the hand object 22b. This makes it possible to express the motion of the hand object 22b and that of the keyboard 26 in synchronization with the user's hands. It will be understood by those skilled in the art that the display image in the illustration is only an example and that various expressions can be devised by use of the hand object.

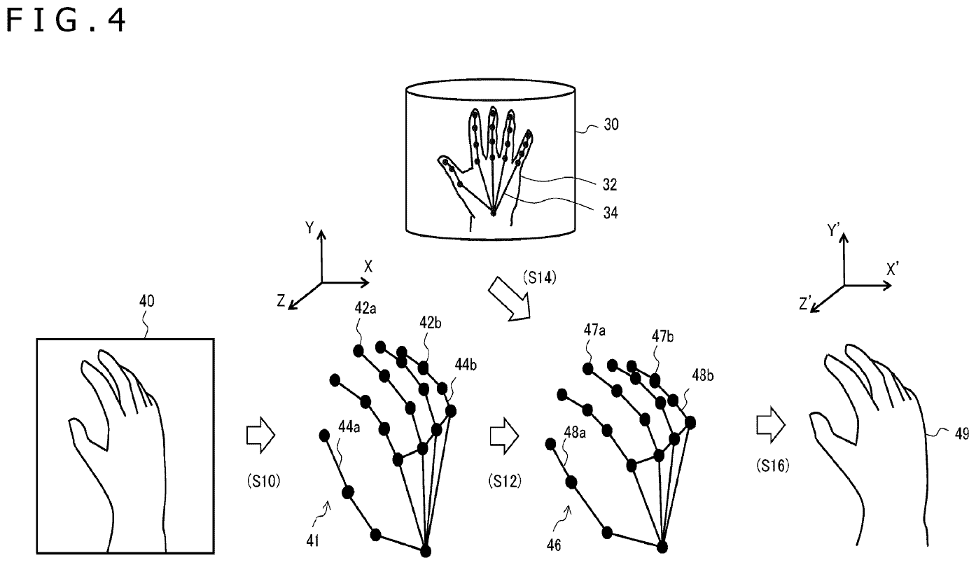

FIG. 4 is a view schematically depicting basic steps to have the state information regarding a real hand reflected in a hand object according to the embodiment of the present disclosure. The content processing apparatus 200 first obtains, from the head-mounted display 100, an image 40 captured by the camera 110. In practice, the content processing apparatus 200 may acquire as many images captured by as many cameras 110 attached to the head-mounted display 100 in time steps corresponds to a given frame rate.

The content processing apparatus 200 extracts a region of the hand from the captured image using known techniques such as pattern matching, and acquires three-dimensional position information regarding feature points of the hand as state information 41 (step S10). In the example of the illustration, the position coordinates of nodes that determine the shape of the hand such as joints, fingertips, and wrist (e.g., nodes 42a and 42b), as well as the positions and postures of bones that connect the nodes (e.g., bones 44a and 44b) are identified in the real space (XYZ space).

The use of a deep neural network (DNN) is a conceivable but not the only method by which the content processing apparatus 200 acquires the state information from the captured image 40. In this case, deep learning is made of numerous hand images constituting training data beforehand so as to prepare model data of DNN that receives input of hand images and outputs the state information. The types of neural networks created by deep learning and various training algorithms are well known to those skilled in the art.

It is to be noted that the means by which the content processing apparatus 200 acquires the state information is not limited to deep learning. For example, the content processing apparatus 200 may obtain three-dimensional position coordinates of feature points by the principle of triangulation based on the position coordinates of the corresponding feature points in multiple images captured in different line-of-sight directions. Alternatively, the content processing apparatus 200 may acquire the hand state information using means other than the captured images such as motion sensors attached to the hands.

The content processing apparatus 200 holds the model data of the hand objects in an internal storage device 30. In the illustration, topographic data 32 such as polygon data and texture data and a skeleton model 34 for controlling the hand state, i.e., a shape, a position, and posture, are schematically indicated as the model data. However, the above model data is not limitative of the model data regarding objects. The content processing apparatus 200 causes the state information 41 regarding the actual hand obtained in step S10 to be fitted to a hand object model (steps S12 and S14).

That is, the content processing apparatus 200 fits the nodes in the hand state information 41 (e.g., nodes 42a and 42b) to the corresponding nodes in the skeleton model 34 of the hand object (e.g., nodes 47a and 47b). The content processing apparatus 200 also fits the bones in the hand state information 41 (e.g., bones 44a and 44b) to the corresponding bones in the skeleton model 34 of the hand object (e.g., bones 48a and 48b).

Generally, the three-dimensional model of an object is defined within content or provided through an application programming interface (API). For this reason, there may occur differences between the user's hand and the object hand in terms of hand modeling such as finger lengths and thicknesses, palm size, a ratio of palm size to finger lengths, and a ratio between finger lengths. There can also be detection errors included in the state information 41 acquired from captured images. This may require the content processing apparatus 200 to derive a skeleton model 46 that is as close to the state information as possible while representing a natural state. This process is called “fitting” in this embodiment.

The content processing apparatus 200 applies polygon data and texture data to the post-fitting skeleton model 46, thereby rendering a hand object 49 in a virtual three-dimensional space (X′Y′Z′ space) (step S16). The content processing apparatus 200 can display the hand object 49 moving synchronously with the actual hand by repeating the process in the illustration at a predetermined rate. Meanwhile, the hand object 49 can develop small deviations stemming from differences in modeling relative to the actual hand, from fitting errors, and from state information errors. This problem can become apparent particularly in scenes where detailed expressions are used, such as gesturing by hands and interactions with other objects as indicated in FIGS. 3A and 3B.

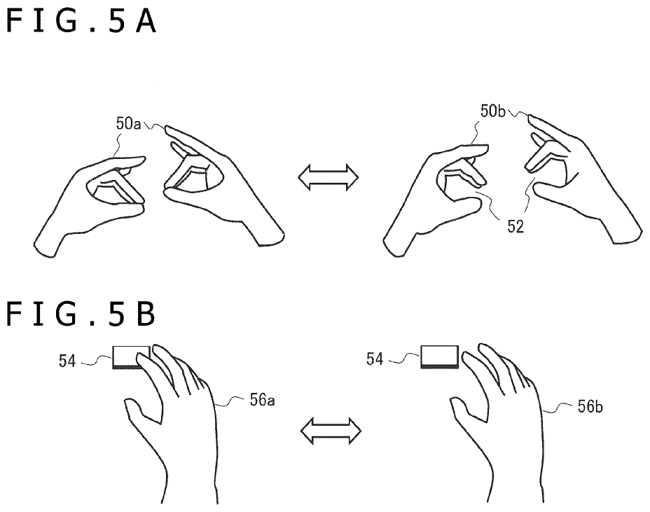

FIGS. 5A and 5B depict views illustrating problems resulting from display deviations of the hand object. The illustration in FIG. 5A assumes a gesture involving the middle and ring fingers touching the thumb, as depicted in FIG. 3A. When the occurrence of that gesture is determined by calculation based on the state information acquired from the captured image, that state may be normally required to be displayed as objects 50a. However, the above-described factors can create gaps 52 between the fingertips in objects 50b, which can be viewed as an incomplete gesture.

As depicted in FIG. 3B, the illustration in FIG. 5B assumes a state in which a key 54 in the virtual space is pressed by a fingertip. When a touch of the index finger on the key 54 is determined by calculation based on the state information acquired from the captured image, that state may be normally required to be displayed as an object 56a. However, the above-described factors can cause the index finger apparently to not reach or to deviate from the key 54 as in an object 56b, which can be viewed as the key 54 not being pressed.

It may be conceivable that the hand object is modified upon determination of a touch between fingers or a touch of a finger on another object in a manner eliminating the display deviations. This, however, can lead to another problem such as distorted modeling of the hand defined by an object model or an abrupt or unnatural movement taking place. In this embodiment, a spring model is introduced between nodes or between an object and the corresponding node in the fitting to a skeleton model and upon touch operations. This allows the touch operations to be expressed with natural movements while facilitating the fitting.

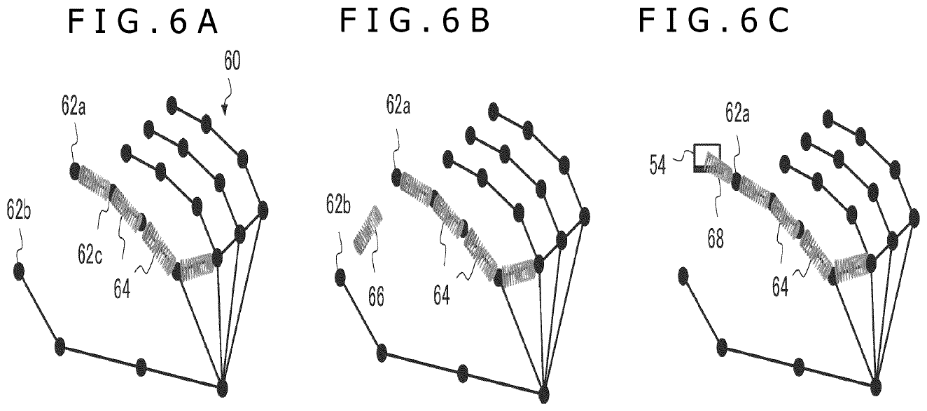

FIGS. 6A, 6B, and 6C depict views illustrating how spring models are introduced in setting a skeleton model of the hand. FIG. 6A indicates an example of setting spring models in a case where a touch between fingertips is not considered. In the manner described above, the content processing apparatus 200 acquires state information 60 including the position coordinates of nodes indicated by black circles (e.g., nodes 62a, 62b, and 62c) and the positions and postures of bones therebetween. In order to fit the state information 60 to a skeleton model of the object, the content processing apparatus 200 sets spring models (e.g., spring models 64) in the positions corresponding to the bones between the nodes included in the state information.

Here, the wording “apply spring models” means that with an ideal distance between nodes taken as a natural spring length, the position coordinates of the nodes are adjusted by applying attraction force to the nodes if the distance between the nodes is longer than the ideal distance and by applying repulsive force thereto if the node-to-node distance is less than the ideal distance, the amount of the force reflecting a magnitude of the difference with the ideal distance. With the spring models applied between the nodes, in the case of a longer-than-ideal distance between some of the nodes in the state information, the excess distance may be distributed to the distances between the other nodes in an appropriately balanced manner corresponding to the object modeling defined by a three-dimensional model. Whereas the springs are indicated only between some of the nodes in the illustration, their numbers and positions are not limited. Preferably, the spring models may be applied to the distances between all the nodes. The same applies to the illustrations in FIGS. 6B and 6C, to be discussed below.

FIG. 6B depicts an example of setting spring models when a gesture involving the index finger touching the thumb is predicted. The content processing apparatus 200 adjusts the distance between the node 62a corresponding to the tip of the index finger on one hand and the node 62b corresponding to the tip of the thumb on the other hand in such a manner that the fingertip surfaces of thick objects touch each other exactly at the time the actual fingertips touch each other. In adjusting the distance, the content processing apparatus 200 predicts the fingertips touching each other on the basis of the state information obtained from the captured image.

The content processing apparatus 200 then introduces a spring model 66 between the nodes 62a and 62b corresponding to the fingertips predicted to touch each other. When the natural length of the spring model 66 is taken as the ideal distance between the nodes corresponding to the object fingertips touching each other, it is possible to perform control such that the nodes 62a and 62b attract each other before eventually stopping at the ideal distance therebetween. As a result, the gaps 52 indicated in the objects 50b in FIG. 5A do not develop. With the spring models (e.g., spring models 64) applied between the other nodes, the force from the spring model 66 is distributed in such a manner as to arrange all the nodes in an appropriately balanced manner.

FIG. 6C depicts an example of setting a spring model when the index finger is predicted to touch the key 54. The content processing apparatus 200 adjusts the distance between the node 62a corresponding to the tip of the index finger on one hand and a point of touch on the key 54 on the other hand in such a manner that the fingertip surface of a thick object touches the key 54 exactly at the time the actual finger reaches the position corresponding to the key 54. In adjusting the distance, the content processing apparatus 200 predicts the index finger touching the key 54 on the basis of the state information obtained from the captured image.

The content processing apparatus 200 then introduces a spring model 68 between the node 62a corresponding to the tip of the index finger and the point of touch on the key 54. When the natural length of the spring model 68 is taken as the ideal distance between the node 62a and the point of touch on the key 54, it is possible to perform control such that the node 62a is attracted to the point of touch before eventually stopping at the ideal distance therebetween. As a result, a deviation from the key 54 indicated in the object 56b in FIG. 5B does not occur. With the spring models (e.g., spring models 64) applied between the other nodes, the force from the spring model 68 is distributed in such a manner that all the nodes are arranged in an appropriate balance.

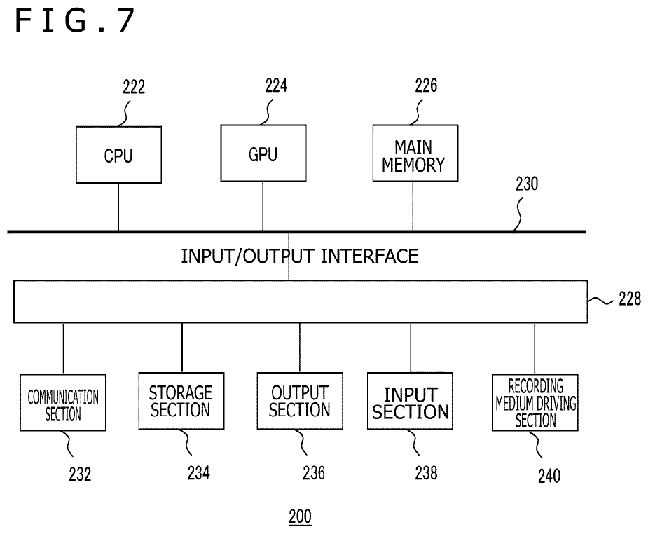

FIG. 7 is a view depicting an internal circuit configuration of the content processing apparatus 200. The content processing apparatus 200 includes a central processing unit (CPU) 222, a graphic processing unit (GPU) 224, and a main memory 226. These components are interconnected via a bus 230. The bus 230 is further connected with an input/output interface 228. The input/output interface 228 is connected with a communication section 232, a storage section 234, an output section 236, an input section 238, and a recording medium driving section 240.

The communication section 232 includes a peripheral interface such as USB and a network interface such as a wired or wireless local area network (LAN). The storage section 234 includes a hard disk drive and a nonvolatile memory. The output section 236 outputs data to the head-mounted display 100. The input section 238 receives input of data from the head-mounted display 100. The recording medium driving section 240 drives a removable recording medium such as a magnetic disk, an optical disk, or a semiconductor memory.

The CPU 222 controls the entire content processing apparatus 200 by executing an operating system stored in the storage section 234. Also, the CPU 222 executes various programs read from the storage section 234 or from the removable recording medium and loaded into the main memory 226 or downloaded via the communication section 232. The GPU 224 has the functions of both a geometry engine and a rendering processor. The GPU 224 performs rendering processing in accordance with rendering instructions from the CPU 222 and outputs the result of the rendering to the output section 236. The main memory 226 is configured by a random access memory (RAM) and stores the programs and data used for processing.

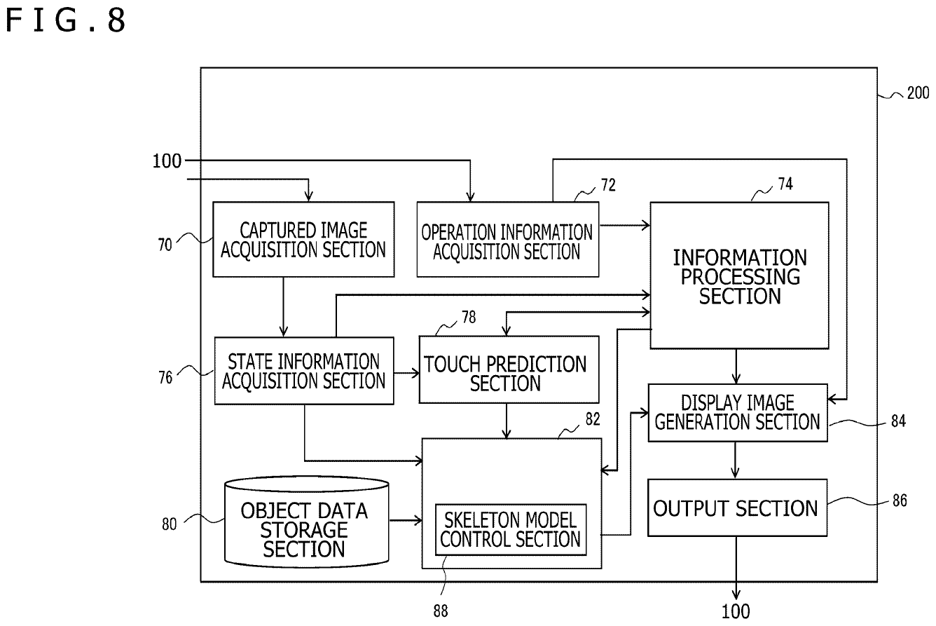

FIG. 8 is a view depicting functional blocks of the content processing apparatus 200. Whereas the component devices of the apparatus may perform general information processing such as advancing of applications and communication with servers, FIG. 8 indicates, in particular, the functional blocks related to a display image generation process including rendering of virtual objects. From this perspective, the content processing apparatus 200 may be implemented as a display image generation apparatus. At least some of the functions of the content processing apparatus 200 in FIG. 8 may be included in the server connected therewith or may be incorporated in the head-mounted display 100.

Multiple functional blocks indicated in FIG. 8 may be implemented by hardware using the circuits depicted in FIG. 7 or realized by software using a computer program incorporating the functions of the multiple functional blocks. It will thus be understood by those skilled in the art that these functional blocks can be implemented by hardware alone, by software alone, or by a combination of both in diverse forms and that the implementation is not limited to a particular form.

The content processing apparatus 200 includes a captured image acquisition section 70 that acquires the data of captured images, an operation information acquisition section 72 that acquires information regarding details of user operations, a state information acquisition section 76 that acquires hand state information from captured images, a touch prediction section 78 that predicts touch operations based on the state information, an object data storage section 80 that stores the data of the objects to be displayed, and a three-dimensional space control section 82 that controls the three-dimensional space targeted for display. The content processing apparatus 200 further includes an information processing section 74 that performs information processing based on details of user operations and on hand state information, for example, a display image generation section 84 that generates display images, and an output section 86 that outputs display image data.

The captured image acquisition section 70 acquires instantaneously, at a predetermined rate, the frame data of moving images captured by the cameras 110 of the head-mounted display 100. The captured image acquisition section 70 may further detect a region of the hand in the captured image by pattern matching, for example, in order to clip the detected region. The operation information acquisition section 72 acquires the details of user operations performed on the ongoing content, the operation details sent typically from a controller, not depicted. Also, the operation information acquisition section 72 acquires the position and posture of the head-mounted display 100, as well information regarding the position and posture of the user's head by the above-mentioned V-SLAM or by use of various kinds of sensor data.

The state information acquisition section 76 acquires the hand state information in time steps based on the images captured by the captured image acquisition section 70. For example, the state information acquisition section 76 extracts the feature points of the hands such as contours and joints from multiple images captured simultaneously by multiple cameras 110. On the basis of the position coordinates of the corresponding feature points in the images, the state information acquisition section 76 obtains the three-dimensional position coordinates of the feature points by the principle of triangulation. Alternatively, the state information acquisition section 76 may acquire the hand state information by the above-mentioned DNN or by use of motion sensors attached to the hands, for example, or integrate the state information acquired by multiple means.

The touch prediction section 78 predicts whether or not a portion such as the hand or its fingertip will touch something within a predetermined time period on the basis of the hand state information acquired by the state information acquisition section 76. In a case where such a touch is predicted, the touch prediction section 78 identifies a candidate that may be touched. Here, the touch candidate may be any of other portions of the actual hand, the other actual hand, and an object in a virtual space. That is, the touch prediction section 78 may predict a touch both in the real space and in the virtual space as long as the touch is to be reflected in the object of the hand. In the description that follows, the target that can become the touch candidate in the real space and in the virtual space will be generically referred to as “the other object.”

The method by which the touch prediction section 78 predicts a touch with the other object is not limited to anything specific. For example, when the other object enters a predetermined range in the real or virtual space around the fingertip position indicated by the hand state information, the touch prediction section 78 predicts a touch with that object. Alternatively, on the basis of a history of movements of the fingertip in the real or virtual space, the touch prediction section 78 may predict subsequent movements of the fingertip. The other object within a predetermined range around the point predicted to be reached by the fingertip upon elapse of a predetermined time period may then be regarded as the touch candidate.

In any case, the faster the movement of the finger determined from the state information, the wider the range for detecting the touch candidate set by the touch prediction section 78. Further, the longer the time used for internal processing by the content processing apparatus 200 and the longer the delay time before image display, the wider the range for touch candidate detection established by the touch prediction section 78. This makes it possible to prepare probable spring models for the other object that may be potentially touched, which reduces lapses such as an unpredicted touch causing the fingertip to vary abruptly.

On the other hand, in a case where the finger moves slowly, making the range for touch candidate detection wider than necessary can create conditions overly constraining the other object. This will conceivably lead to jitters in which even slight fingertip movements cause the fingertip to vary repeatedly. In view of this, the touch prediction section 78 may temporarily stop the prediction operation when a speed of the hand or fingertips is less than a threshold value. In this case, the other object predicted so far to be touched may be maintained as the touch candidate. It is to be noted that the target predicted by the touch prediction section 78 for a possible touch is not limited to the fingertips.

In predicting a fingertip touch, the touch prediction section 78 may either predict a touch of all five fingertips or may limit the prediction to the operating finger such as the index finger. Alternatively, the touch prediction section 78 may set a different range for touch candidate detection for each different finger depending on its probability of engaging in an operation. As another alternative, the touch prediction section 78 may change the rules for selecting the operating finger or the range for touch candidate detection set for each different finger according to the details of the content or the scene to be displayed. During a period in which the fingertips are hidden from view such as in the case of a closed fist, the touch prediction section 78 may temporarily stop the prediction function.

On the basis of the latest state information determined by the state information acquisition section 76, the three-dimensional space control section 82 controls a virtual three-dimensional space that includes the hand object. The three-dimensional space control section 82 includes a skeleton model control section 88 that controls the skeleton model of the hand object when the latter is set in the three-dimensional space. The skeleton model control section 88 performs, at a predetermined rate, the process of optimizing the position coordinates of the nodes in the latest state information using spring models. Specifically, the skeleton model control section 88 applies the spring models between the nodes before fitting the nodes to the skeleton model of the hand object. Also, the skeleton model control section 88 applies the spring model between the touch candidate and the node corresponding thereto for expression without touch deviations.

In applying the spring models, it is possible to use known calculation methods adopted in diverse fields such as physical simulation. As discussed above, the skeleton model control section 88 applies force to the nodes in the state information in such a manner that the distance between the nodes as well as the distance between a touch point of the touch candidate and the node corresponding thereto will approach the ideal distance. With all the nodes thus arranged in an appropriately balanced manner, the skeleton model control section 88 derives their three-dimensional position coordinates using the spring models. A specific example of the processing performed by the skeleton model control section 88 will be discussed later. The object data storage section 80 stores the data of three-dimensional models of the objects in the display world. The stored data includes the hand model data including the skeleton model 34 indicated in FIG. 4.

The information processing section 74 performs information processing on the content such as an electronic game based on the details of user operations acquired by the operation information acquisition section 72, on the hand state information acquired by the state information acquisition section 76, and on the touch operations predicted by the touch prediction section 78. For example, the information processing section 74 determines a command input by a hand gesture based on the hand state information, and carries out processing accordingly. Alternatively, the information processing section 74 may execute interactions with the hand object by suitably varying the state of the other object confirmed to be touched by the hand. The details and the purposes of the processing performed by the information processing section 74 are not limited to anything specific.

The information processing section 74 may request the three-dimensional space control section 82 to have a result of the information processing reflected in the three-dimensional space of the display world. This makes it possible not only to have the hand motion in the real world reflected in the hand object but also to vary the other object in keeping with the progress of the content and the interactions with the hand object.

In a case where a touch of the hand on the other object is predicted in the course of information processing, the information processing section 74 may notify the touch prediction section 78 of the predicted touch. For example, in a case where an operation to move the hand object is allowed separately to be performed by a controller, the information processing section 74 acquires the details of that operation from the operation information acquisition section 72, predicts a touch of the hand object on the other object accordingly, and notifies the touch prediction section 78 of the predicted touch. In this case, the touch prediction section 78 may notify the three-dimensional space control section 82 that the communicated other object is the touch candidate.

The display image generation section 84 renders, at a predetermined frame rate, an image depicting how things look like in the virtual three-dimensional space controlled by the three-dimensional space control section 82. At this time, the display image generation section 84 may vary the field of view regarding the virtual three-dimensional space in keeping with the movements of the user's head. The output section 86 outputs successively the frame data of the generated display image to the head-mounted display 100.

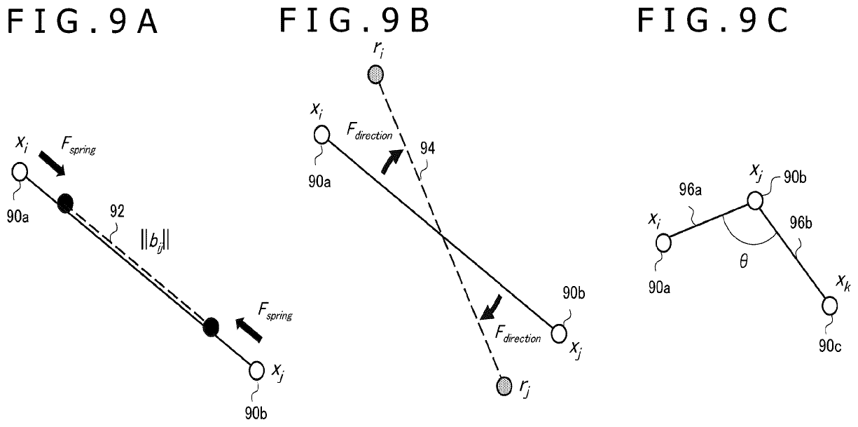

FIGS. 9A, 9B, and 9C depict views for explaining a specific example of a method by which the skeleton model control section 88 fits state information to a skeleton model. The skeleton model control section 88 displaces the nodes included in the state information by applying spring modes to the nodes using the calculations below, for example, so as to obtain the position coordinates of the nodes arranged in an appropriately balanced manner.

$${x}_{ij} = {x}_{i} - {x}_{j} \qquad [ Math . 1 ]$$

$$\hat{x} = \frac{x}{‖ x ‖}$$

$$For i , j in edges do$$

$${F}_{spring} = {α}_{spring} \cdot {\hat{x}}_{ij} \cdot ( ‖ {x}_{ij} ‖ - ‖ {b}_{ij} ‖ )$$

$${F}_{direction} = {α}_{direction} \cdot ( {\hat{x}}_{ij} \times ( {\hat{r}}_{ij} \times {\hat{x}}_{ij} ) ) \cdot ‖ {\hat{x}}_{ij} - {\hat{r}}_{ij} ‖$$

$${x}_{i} ← {x}_{i} - {F}_{spring} - {F}_{direction}$$

$${x}_{j} ← {x}_{j} + {F}_{spring} + {F}_{direction}$$

In the above calculations, xᵢ and xⱼ stand for the three-dimensional position coordinates of two nodes 90a and 90b connected by one bone (edge), and ∥bᵢⱼ∥ denotes the length of a corresponding edge 92 in the skeleton model of the object, i.e., the distance between the nodes. As depicted in FIG. 9A, F_{spring} represents the force of the spring exerted in an edge length direction on the nodes 90a and 90b having the position coordinates xᵢ and xⱼ, with ∥bᵢⱼ∥ taken as the reference. Also, rᵢ and rⱼ denote the initial values of the three-dimensional position coordinates of the above two nodes 90a and 90b. As depicted in FIG. 9B, F_{direction} represents stress (elastic force) in a rotation direction in reference to a direction of an initial edge 94. The stress F_{direction} is applied in such a manner that a positional relation between the nodes displaced by the force F_{spring} will not deviate from the initial positional relation to change the edge orientation unnaturally.

In the above calculations, α_{spring} and α_{direction} stand for the factors putting weights on F_{spring} and F_{direction}, respectively. The skeleton model control section 88 repeats the calculations above a predetermined number of times (e.g., 32 times) on all nodes to let their position coordinate values converge on the eventual position coordinates. Qualitatively, the larger the factors α_{spring} and α_{direction}, the faster the convergence but the higher the risk of jitters; the smaller the factors α_{spring} and α_{direction}, the slower the convergence but the lower the risk of jitters. In view of this, the factors are set appropriately beforehand to let the values converge through the calculations carried out a predetermined number of times.

After adjusting the position coordinates of the nodes by the above calculations, the skeleton model control section 88 determines whether or not the resulting angle of the finger (i.e., angle formed by the continuous body segments) is realistic. If the obtained angle is not realistic, the skeleton model control section 88 may further adjust the position coordinates of the nodes. That is, as depicted in FIG. 9C, the skeleton model control section 88 obtains an angle θ formed by two edges 96a and 96b between three nodes 90a, 90b, and 90c of the position coordinates xᵢ, xⱼ, and xₖ obtained by the above calculations. If the angle θ is determined to exceed an upper or lower limit delineating a realistic range, then the skeleton model control section 88 adjusts the position coordinates xᵢ, xⱼ, and xₖ in such a manner that the angle θ will fall within the realistic range.

In practice, the angle θ may be an azimuth angle and a zenith angle of one of two edges, one edge being taken as the axis of the other edge. The skeleton model control section 88 performs similar determination on all pairs of edges connected by the nodes and adjusts the position coordinates of the nodes as need. It is to be noted that the timing with which the skeleton model control section 88 adjusts the nodes based on the angles therebetween is not limited to anything specific. Qualitatively, under a constraint condition that the angle should fall within a predetermined range, the skeleton model control section 88 may adjust the positions of the nodes using spring models, for example.

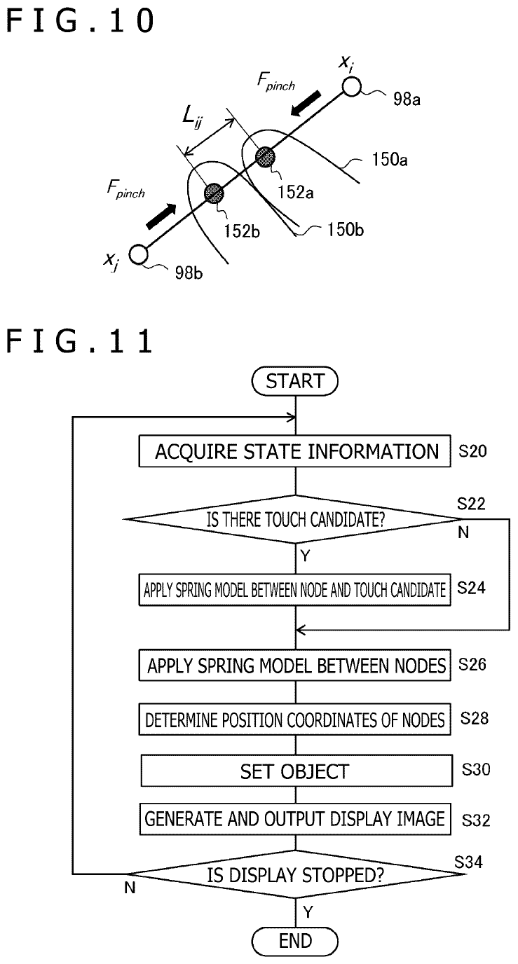

FIG. 10 is a view for explaining a specific example of a method by which the skeleton model control section 88 causes a touch operation to be reflected in a skeleton model. Upon detection of the touch candidate by the touch prediction section 78, the skeleton model control section 88 may perform the calculations below, for example, in addition to the above calculations for the fitting. The following calculations allow the skeleton model control section 88 to displace the nodes by applying the spring model between a point of touch on the touch candidate and the corresponding node of the finger predicted to touch the candidate, so as to obtain the position coordinates of the nodes permitting expression of a naturally performed touch.

$$For i , j in pinch pairs \qquad [ Math . 2 ]$$

$${F}_{pinch} = {α}_{pinch} \cdot {x}_{ij} \cdot ( ‖ {x}_{ij} ‖ - {L}_{ij} ) \cdot max ( 1 - \frac{\text{?}}{T} , 0 )$$

$${x}_{i} ← {x}_{i} - {F}_{pinch}$$

$${x}_{j} ← {x}_{j} + {F}_{pinch}$$

$$\text{?} \text{indicates text missing or illegible when filed}$$

The formula above assumes a situation where a fingertip having the node represented by the position coordinate xᵢ and another fingertip having the node represented by the position coordinate xⱼ touch each other. One such situation may be the thumb and the index finger touching each other in what is known as a pinch operation. As depicted in FIG. 10, Lᵢⱼ denotes an ideal distance between such nodes 98a and 98b, i.e., the distance between nodes 152a and 152b at the time the surfaces of object fingers 150a and 150b touch each other. That is, the length Lᵢⱼ is a parameter dependent on thicknesses of the object fingers 150a and 150b. With the length Lᵢⱼ taken as the reference, force F_{pinch} is exerted on the nodes 98a and 98b having the position coordinates xᵢ and xⱼ in the edge length direction. A coefficient α_{pinch} denotes the weight exerted on the force F_{pinch}. As with the factors α_{spring} and α_{direction}, an appropriate value of the coefficient α_{pinch} is obtained beforehand.

The value Sᵢⱼ represents a degree of attainment to a touch state. The value Sᵢⱼ is 0.0 in the initial state of the nodes, 1.0 in the state of the fingers touching each other, and a variable therebetween that increases monotonically as the distance between the fingertips decreases. The term T denotes an upper limit on the distance between the fingertips at the time force is exerted by the spring for the touch operation. In the above calculations, the maximum operator has two effects: the effect of making a spring constant larger the shorter the distance between the fingertips, and the effect of disabling the spring force F_{pinch} in a case where the distance exceeds the limit T. The former effect averts an unnatural movement of the approaching fingertips abruptly attracted to each other like magnets when a predetermined distance is reached. The latter effect prevents the spring force from arising until a predetermined distance is reached where the spring models are applied to all touch candidates on which a touch is predicted by the touch prediction section 78.

Thus, the skeleton model control section 88 may perform the above calculations on all pairs of fingertips that can touch each other. In a case where the touch candidate is something other than the hands such as a virtual keyboard and where the position coordinate xⱼ of one of the two nodes in the above calculations is fixed, then a touch of the fingertip on the object can be expressed naturally by similar calculations. In this case, the ideal distance Lᵢⱼ is assumed to be such that when the surface of the object finger touches the object of the touch candidate, the ideal distance Lᵢⱼ is the distance between a point of touch on the object surface and the node corresponding to the fingertip.

Explained next is the operation of the content processing apparatus 200 that may be implemented in this embodiment. FIG. 11 is a flowchart indicating a processing procedure performed by the content processing apparatus 200 to generate and output a display image that includes a hand object reflecting the movement of the user's hand. The procedure of this flowchart is started in a state where the content processing apparatus 200, having established communication with the head-mounted display 100 worn by the user, has acquired therefrom the frame data of the captured image, details of user operations, and data regarding the position and posture of the user's head.

First, the state information acquisition section 76 of the content processing apparatus 200 acquires state information regarding the user's hand based on the frames of the captured image (step S20). The state information includes at least the three-dimensional position coordinates of the nodes of the hand. If the touch prediction section 78 has not detected any touch candidate based on the state information so far (No in step S22), the skeleton model control section 88 in the three-dimensional space control section 82 applies spring models between the nodes of the hand (step S26), so as to obtain the position coordinates of the nodes fitted to the skeleton model of the object (step S28).

In a case where the touch prediction section 78 has detected any touch candidate (Yes in step S22), the skeleton model control section 88 applies a spring model between a point of touch of the touch candidate and the finger's node predicted for a touch (step S24), and also applies spring models between the other nodes (step S26) so as to determine the position coordinates of these nodes (step S28). This makes it possible, with the distance to the touch candidate taken as the constraint condition, to obtain the position coordinates of the nodes close to the skeleton model of the object.

The three-dimensional space control section 82 sets the hand object in the virtual three-dimensional space by applying a polygon, for example, to the skeleton model having the nodes defined by the position coordinates determined in step S28 (step S30). In parallel with this, the three-dimensional space control section 82 may have the result of the information processing reflected in each of the objects in the virtual three-dimensional space according to requests from the information processing section 74. The display image generation section 84 generates the frame data of the display image by rendering the object in the latest state in the virtual three-dimensional space, and outputs the generated data successively to the head-mounted display 100 (step S32).

If there is no need to stop the display, for example, by termination of the content or by the user's operation (No in S34), the content processing apparatus 200 repeats steps S20 through S32 at a predetermined rate. This makes it possible to render the hand object with low delay and high accuracy and to express naturally how the fingertip touches the other object. The frequency of the processing in steps S20 through S26 may be either the same as the frame rate of display or lower than the display frame rate. In the case where the frequency of the processing is lower than the display frame rate, the position coordinates of the nodes at a given frame rate may be estimated by extrapolation based on the position coordinates of the frames so far. When there is a need to stop the display, the content processing apparatus 200 terminates the whole processing (Yes in step S34).

According to the above-described embodiment of this disclosure, at the time the state of the target is reflected in the skeleton model of the object in a mode where the motion of the target in the real world is reflected in a displayed object, spring models are applied between the nodes involved. This makes it possible to express, with low delay and high accuracy, the object that reflects the state of the target and is arranged in an appropriate modeling balance defined by the three-dimensional model.

A touch between fingertips and a touch of a fingertip on another virtual object are predicted, with spring models also applied therebetween. This makes it possible to prevent the occurrence of a gap or a misalignment with the touch target on the display due to differences in modeling between the real thing and the object or due to errors in the state information, thereby expressing how a gesture is formed or how a touch is made in natural movements. As a result, it is possible to enhance the quality of the content representing the object synchronized with actual movements in diverse situations.

While the present disclosure has been described in conjunction with a specific embodiment given as an example, it should be understood by those skilled in the art that the above-described composing elements and various processes may be combined in diverse ways and that such combinations, variations and modifications also fall within the scope of this disclosure.

For example, in the above-described embodiment, the hand state information is reflected in the skeleton model of the hand object. Calculations similar to those discussed above provide similar advantageous effects in a case where another body portion or the whole body other than the hands is reflected in the skeleton model of the corresponding object. For example, if the movement of the entire body is to be reflected in a human object, there may be more positions of the nodes set in the object than in the case of the hands.

The present disclosure may include the following modes.

### [Item 1]

A display image generation apparatus including:
a circuitry configured to implement the following, in which
the circuitry
   acquires state information in a three-dimensional space regarding a target in a real world,
   applies a spring model to a position corresponding to a bone between nodes represented by the state information so as to adjust positions of the nodes, the spring model having a natural length constituting an ideal distance on the basis of a skeleton model of a virtual object corresponding to the target, and
   generates a display image including the virtual object reflecting the skeleton model formed by the adjusted nodes.

### [Item 2]

The display image generation apparatus according to Item 1, in which
the circuitry
   detects a touch candidate predicted to touch the target on the basis of the state information, and,
   when adjusting the positions of the nodes, further applies a spring model between the touch candidate and the node corresponding thereto, the spring model having a natural length constituting an ideal distance at the time of the touch.

### [Item 3]

The display image generation apparatus according to Item 2, in which the circuitry applies the spring model between two nodes, one node corresponding to a fingertip constituting the target, the other node corresponding to another fingertip forming the touch candidate, so as to adjust the positions of the two nodes.

### [Item 4]

The display image generation apparatus according to Item 3, in which the circuitry determines the ideal distance on the basis of a thickness of the finger forming the virtual object.

### [Item 5]

The display image generation apparatus according to Item 2, in which the circuitry applies the spring model between two nodes, one node corresponding to a fingertip constituting the target, the other node corresponding to another virtual object forming the touch candidate, so as to adjust the position of the node corresponding to the fingertip.

### [Item 6]

The display image generation apparatus according to Item 1, in which, when adjusting the positions of the nodes, the circuitry applies stress to the nodes in a rotation direction with regard to a directional change of the bone between the nodes in reference to an initial position of the nodes.

### [Item 7]

The display image generation apparatus according to Item 1, in which, under a constraint condition that an angle between two bones connected by the nodes should fall within a predetermined range, the circuitry adjusts the positions of the nodes.

### [Item 8]

The display image generation apparatus according to Item 2, in which, the shorter the distance between the touch candidate and the node corresponding thereto, the larger the circuitry makes a spring constant for the spring model applied therebetween.

### [Item 9]

The display image generation apparatus according to Item 2, in which, when the distance between the touch candidate and the node corresponding thereto exceeds a predetermined value, the circuitry disables force of the spring model applied therebetween.

### [Item 10]

A display image generation method including:
acquiring state information in a three-dimensional space regarding a target in a real world;
applying a spring model to a position corresponding to a bone between nodes represented by the state information so as to adjust the positions of the nodes, the spring model having a natural length constituting an ideal distance based on a skeleton model of a virtual object corresponding to the target; and
generating a display image including the virtual object reflecting the skeleton model formed by the adjusted nodes.

### [Item 11]

A recording medium that records a program for a computer, the program including:
by a circuitry,
acquiring state information in a three-dimensional space regarding a target in a real world;
applying a spring model to a position corresponding to a bone between nodes represented by the state information so as to adjust the positions of the nodes, the spring model having a natural length constituting an ideal distance based on a skeleton model of a virtual object corresponding to the target; and
generating a display image including the virtual object reflecting the skeleton model formed by the adjusted nodes.

What is claimed is:

1. A display image generation apparatus comprising:
a state information acquisition section configured to acquire state information in a three-dimensional space regarding a target in a real world;
a skeleton model control section configured to apply a spring model to a position corresponding to a bone between nodes represented by the state information so as to adjust positions of the nodes, the spring model having a natural length constituting an ideal distance based on a skeleton model of a virtual object corresponding to the target; and
a display image generation section configured to generate a display image including the virtual object reflecting the skeleton model formed by the adjusted nodes.

2. The display image generation apparatus according to claim 1, further comprising:
a touch prediction section configured to detect a touch candidate predicted to touch the target on a basis of the state information, wherein,
when adjusting the positions of the nodes, the skeleton model control section further applies a spring model between the touch candidate and the node corresponding thereto, the spring model having a natural length constituting an ideal distance at the time of the touch.

3. The display image generation apparatus according to claim 2, wherein the skeleton model control section applies the spring model between two nodes, one node corresponding to a fingertip constituting the target, the other node corresponding to another fingertip forming the touch candidate, so as to adjust the positions of the two nodes.

4. The display image generation apparatus according to claim 3, wherein the skeleton model control section determines the ideal distance on a basis of a thickness of the finger forming the virtual object.

5. The display image generation apparatus according to claim 2, wherein the skeleton model control section applies the spring model between two nodes, one node corresponding to a fingertip constituting the target, the other node corresponding to another virtual object forming the touch candidate, so as to adjust the position of the node corresponding to the fingertip.

6. The display image generation apparatus according to claim 1, wherein, when adjusting the positions of the nodes, the skeleton model control section applies stress to the nodes in a rotation direction with regard to a directional change of the bone between the nodes in reference to an initial position of the nodes.

7. The display image generation apparatus according to claim 1, wherein, under a constraint condition that an angle between two bones connected by the nodes should fall within a predetermined range, the skeleton model control section adjusts the positions of the nodes.

8. The display image generation apparatus according to claim 2, wherein, the shorter the distance between the touch candidate and the node corresponding thereto, the larger the skeleton model control section makes a spring constant for the spring model applied therebetween.

9. The display image generation apparatus according to claim 2, wherein, when the distance between the touch candidate and the node corresponding thereto exceeds a predetermined value, the skeleton model control section disables force of the spring model applied therebetween.

10. A display image generation method comprising:
acquiring state information in a three-dimensional space regarding a target in a real world;
applying a spring model to a position corresponding to a bone between nodes represented by the state information so as to adjust the positions of the nodes, the spring model having a natural length constituting an ideal distance based on a skeleton model of a virtual object corresponding to the target; and
generating a display image including the virtual object reflecting the skeleton model formed by the adjusted nodes.

11. A computer program for a computer, comprising:
by a state information acquisition section, acquiring state information in a three-dimensional space regarding a target in a real world;
by a skeleton model control section, applying a spring model to a position corresponding to a bone between nodes represented by the state information so as to adjust the positions of the nodes, the spring model having a natural length constituting an ideal distance on based on a skeleton model of a virtual object corresponding to the target; and
by a display image generation section, generating a display image including the virtual object reflecting the skeleton model formed by the adjusted nodes.
